(19) United States
(12) Patent Application Publication
(10) Pub. No.: US 2021/0185217 A1
(43) Pub. Date: Jun. 17, 2021

(54) REMOTE CONTROL UNIT FOR A MOTION PICTURE CAMERA

(71) Applicant: Arnold & Richter Cine Technik GmbH & Co. Betriebs KG, Munchen (DE)

(72) Inventor: Georg Lanz, Munchen (DE)

(21) Appl. No.: 17/102,533

(22) Filed: Nov. 24, 2020

(30) Foreign Application Priority Data
Dec. 11, 2019 (DE) 102019134014.4

(51) Int. Cl. H04N 5/232; G06F 3/16; G06F 3/01

(52) U.S. Cl. CPC H04N 5/23203; G06F 3/165; G06F 3/0362; G06F 3/016; H04N 5/23216; G06F 3/167

(57) ABSTRACT

A remote control unit for a motion picture camera having a lens actuating motor comprises a movable operating element for setting control commands for an associated camera; an evaluation and control device for generating an actuating motor control signal for the camera in dependence on the set control command; a control signal output for transmitting the actuating motor control signal; an operating state signal input for receiving operating state signals from the associated camera; and a feedback signal generator, wherein the evaluation and control device is configured, in response to a received operating state signal that represents a change of the associated camera from a standby state to a recording state, to control the feedback signal generator to generate a camera status feedback signal that is directly or indirectly acoustically and/or haptically perceivable.

The invention relates to a remote control unit for a motion picture camera having a lens actuating motor, comprising a movable operating element for setting control commands for an associated camera; an evaluation and control device for generating an actuating motor control signal for the camera (including a camera objective) in dependence on the set control command; and a control signal output for transmitting the actuating motor control signal to the associated camera.

An electronic motion picture camera typically comprises an integrated optical system (camera objective, camera lens) or a lens mount for mounting an interchangeable objective (interchangeable lens); further an electronic image sensor for generating image signals from incident light; and an image signal processing device for generating a digital image data stream from the image signals. A remote control unit may be provided to control a conventional or an electronic motion picture camera to record moving image recordings and/or to set recording parameters such as the image recording rate, the shutter speed, or the iris aperture opening, the focal position (sharpness), or the focal length (zoom factor) of the camera objective. The setting of the iris aperture opening, of the focal position, and of the focal length may take place by a respective lens actuating motor that is integrated into the camera objective or that is typically arranged as a separate, external unit outside the camera objective and that is connected to a rotatable lens ring of the camera objective to adjust it. The control of the respective lens actuating motor may take place by a remote control unit such as is, for example, known from DE 196 29 484 A1 and WO 2010/046237 A1. A plurality of lens actuating motors may be provided for setting different recording parameters before and in particular during a moving image recording such as is known from DE 42 19 331 A1, for example.

Due to the possibility of a remote-controlled control or setting of the recording parameters of a motion picture camera, it may in particular be achieved that a cameraman guiding the camera may concentrate solely on the correct orientation of the camera, which usually changes during the recording of a scene, in order to maintain the desired image detail. However, the respective corresponding setting of the recording parameters of the camera may, in contrast, be performed by an operator of the remote control unit solely responsible therefor, for example a camera assistant or a focus puller, who may set the respective control commands for the camera at the remote control unit by moving the operating element. The operator may in this respect in particular set a sequence of control commands, which was previously agreed with the cameraman, during a recording.

While such a sequence of control commands for the camera that are to be set may generally be carried out without problem during the recording of a scene by a camera assistant following the scene, coordination difficulties may arise on the start or on the restart of an agreed control sequence due to interruptions or before the start of a shoot. Before the start of a shoot, the motion picture camera may namely be switched on and may be in a standby state in which the camera is ready to record, but no recording is prepared yet. For the start of a shoot, the cameraman in contrast has to switch the motion picture camera to a recording state in order to capture a scene. However, this change of the operating state of the camera to the recording state may be difficult to perceive for a camera assistant or a focus puller possibly positioned remote from the scene since they may possibly not be able to hear instructions at the start of the recording.

To counteract this problem, the remote control unit may signal the recording state of the camera in a visually perceivable manner, for example, by a flashing light.

However, this requires the camera assistant or the focus puller to constantly keep the remote control unit in view in order not to miss the change of the motion picture camera to the recording state. However, this prevents the camera assistant or the focus puller from observing the scene to be recorded (such as the position of actors) and there is the risk that such an optical signal will be overlooked.

It is an object of the invention to provide a remote control unit for a motion picture camera that indicates a change of the camera to the recording state, that is the start of a recording of moving images, to an operator in a reliably perceivable manner.

This object is satisfied by a remote control unit having the features of claim 1 and in particular in that the remote control unit comprises an operating state signal input for receiving operating state signals from the associated camera; and a feedback signal generator, wherein the evaluation and control device is configured, in response to a received operating state signal that represents a change of the associated camera from a standby state to a recording state, to control the feedback signal generator to generate a camera status feedback signal that is directly or indirectly acoustically and/or haptically perceivable.

Since the remote control unit comprises an operating state signal input for receiving operating state signals of the associated camera, a change of the camera from the standby state to the recording state may generally first be transmitted to the remote control unit. As already explained above, the operating state of the camera refers to an operating state in which the camera is usually indeed switched on and is any case ready to record, but no recording takes place. In the recording state, in contrast, the camera is switched on and records the scene (e.g. a direct recording of the image data in the camera or in a connected recorder, or a transmission of the image data for a remote storage or for a broadcast). In general, a camera may also directly start a recording from a switched-off state by a switching on so that the switched-off state also means a standby state of the camera in such cases. However, provision is usually made to first switch on a camera and then to set it into the recording state by a further command, for example by pressing a “REC” button. In all these cases, there is the initially explained problem that the transfer of the camera from the standby state to the recording state was triggered by the cameraman directly at the camera (and not, for instance, due to a control command transmitted by the remote control unit) and that this change may therefore be difficult to perceive for a camera assistant or a focus puller possibly positioned remote from the scene.

The control of the feedback signal generator by means of the evaluation and control device on a determined change of the camera to the recording state and the corresponding generation of a camera status feedback signal make it possible to draw the attention of an operator of the remote control unit to the change of the camera to the recording state that has taken place. Since this feedback signal is acoustically and/or haptically perceivable, it is not necessary in this respect for the operator to constantly follow what is happening in the region of the camera or to constantly keep the remote control unit in view. The operator may thus also stay far away from the camera or may concentrate on the positions of the actors and objects in the scene to be recorded. It is nevertheless ensured that the operator of the remote control unit reliably perceives the actual start of the recording so that the operator may then set a planned or rehearsed sequence of control commands at the remote control unit.

Such a camera status feedback signal that ensures the attention of the operator may, for example, be directly acoustically perceivable since the remote control unit is configured to generate sound directly. For this purpose, the remote control unit may comprise a loudspeaker, for example. Furthermore, the feedback signal generator may be configured to generate indirectly acoustically perceivable camera status feedback signals. For this purpose, the feedback signal generator may, for example in response to the received operating state signal, generate a camera status feedback signal that represents audio information and that is converted into sound by a converter separate from the remote control unit. For this purpose, the feedback signal generator may in particular be connected or connectable to an external loudspeaker or headphones by or at which the sound generation ultimately takes place. Alternatively or additionally, haptically perceivable camera status feedback signals may also be directly perceivable, for example through a vibration of the remote control unit that can be sensed, or indirectly perceivable in that a signal that can actually be sensed is generated by a device that is provided separately from the remote control unit and that can be transported, for example in a trouser pocket, or that can be worn on an arm joint.

The operating state signal input of the remote control unit and the control signal output for transmitting the actuating motor control signal to the camera may form a common module, for example a transceiver, and/or may be part of the evaluation and control device. The evaluation and control device may also be configured as a single unit (e.g. as a discrete or integrated circuit, a microprocessor, ASIC, FPGA) or it may be designed in a modular manner with a plurality of sub-units so that, for example, the control signal output and the operating state signal input may be configured as respective separate modules and may be connected to the evaluation and control device. For example, one subunit of the evaluation and control device may also generate the respective actuating motor control signal in dependence on the set control command, while another subunit (which may e.g. also only be connected in a signal technical manner to the other subunit) controls the feedback signal generator to generate the camera status feedback signal.

The motion picture camera associated with the remote control unit may be configured for the connection of interchangeable objectives. The motion picture camera may thereby be equipped with different camera objectives adapted to the respective scene. The remote control unit may be configured to generate actuating motor control signals for the lens actuating motor or motors of the respective camera objective and to transmit them to the camera or to a control circuit provided internally or separately there. The remote control unit may be universally usable for this purpose, in particular in the case of the typical use of external lens actuating motors.

In some embodiments, the feedback signal generator may have a loudspeaker and the camera status feedback signal may comprise an acoustically perceivable sound signal generated by the loudspeaker. In connection with the invention, the term “loudspeaker” refers to any kind of sound generator (e.g. a piezo sound generator). In such embodiments, the camera status feedback signal is consequently directly acoustically perceivable and an operator of the remote control unit may be made aware of a change of the camera to the recording state directly by the remote control unit.

In accordance with an embodiment, the volume of the sound signal generated by the loudspeaker may be adjustable to be able to ensure a perception of the camera status feedback signal by the operator of the remote control unit, on the one hand, and to be able to avoid a disturbance of other people involved in the recording by the sound signal, on the other hand. For this purpose, the evaluation and control device may, for example, be connected to a corresponding volume regulator of the remote control unit and/or an anyway present input device of the remote control unit (e.g. for inputting control commands or for configuring the remote control unit) may also be used for adjusting the volume of the sound signal.

Alternatively or additionally, the loudspeaker may be selectively switched off to selectively suppress the generation of the acoustically perceivable sound signal. For this purpose, the remote control unit may, for example, have a switch (a mechanical or a virtual switch) by means of which the generation of the acoustically perceivable sound signal may be selectively switched off.

Such a sound signal may in particular comprise a single sound, a sequence of sounds, or a synthetic voice instruction. Furthermore, the sound signal may be repeatedly provided as a single sound to permanently indicate the recording state of the camera, for example.

In general, only the sound signal may be generated, wherein it is also possible that the camera status feedback signal comprises further signals, for example, haptically and/or indirectly acoustically perceivable signals.

The feedback signal generator may have a wired audio signal output and/or a wireless audio signal output via which the camera status feedback signal may be transmitted to a coupled external sound generator. In such embodiments, the camera status feedback signal may consequently be acoustically perceived in an indirect manner, via the external sound generator. A wired audio signal output may in this respect make it possible to transmit an analog or a digital audio signal to a connected sound generator, for example, to an external speaker or to headphones.

In such an embodiment, the feedback signal generator may, for example, comprise a driver that generates an analog driver signal (voltage signal) for the connected sound generator. Due to an audio signal transmitted via a wireless audio signal output, an acoustically perceivable signal may be formed by means of the receiving external sound generator in accordance with the signal format and/or radio protocol used, wherein a Bluetooth connection may in particular be provided. In such an embodiment, the feedback signal generator may, for example, have a radio module that generates the camera status feedback signal as a radio signal in which the audio information is encoded. In this respect, a transmission to an external loudspeaker or to headphones may in particular also be provided.

Due to such a transmission of the camera status feedback signal to an external sound generator and in particular to headphones, an indirectly acoustically perceivable camera status feedback signal may be generated. In particular on the use of headphones as an external sound generator, it may in this respect be achieved that the camera status feedback signal is only perceived by the addressed operator of the remote control unit and not by other persons in the vicinity of the remote control unit. A possible disruption of the recording operation due to a camera status feedback signal that can be heard by all those involved may thereby be avoided.

In some embodiments, the remote control unit may comprise a selector by means of which the generation of the camera status feedback signal may be selectively suppressed. A directly acoustically perceivable feedback signal, which may be disturbing under certain circumstances, may thereby be selectively suppressed during specific recordings or in specific situations if these recordings, for example, anyway require the full attention of all those involved or if, for example in the case of animal recordings, a sound signal may inevitably result in a disruption of the recording.

In some embodiments, the feedback signal generator may have a loudspeaker and a wired and/or wireless audio signal output, wherein the evaluation and control device may be configured, in response to the received operating state signal, to control the feedback signal generator to output the camera status feedback signal via the audio signal output and said evaluation and control device may, however, be configured to suppress an output of a sound signal generated by the loudspeaker when an external sound generator is coupled to the audio signal output. The remote control unit may consequently indeed have a loudspeaker and may thereby be configured to generate a directly acoustically perceivable camera status feedback signal without additional devices generally being necessary. Since an audio signal output is, however, provided in addition to the loudspeaker, such a remote control unit selectively also enables the generation of an indirectly acoustically perceivable camera status feedback signal at an external sound generator, for example at headphones. If such a sound generator is coupled to the audio signal output, it may be achieved by the suppression of the sound signal generated by the loudspeaker that only a signal that is indirectly acoustically perceivable via the external sound generator is generated. In particular on the use of headphones, it may thereby be achieved that the operator of the remote control unit is reliably made aware of a change of the camera to the recording state, while an additional direct sound signal of the loudspeaker, which is unnecessary and possibly disturbing in this case, is suppressed.

To achieve an automatic suppression of the sound signal generated by the loudspeaker, the evaluation and control device may be configured to detect the coupling of an external sound generator, in particular of headphones, to the audio signal output and consequently to suppress the output of a sound signal generated by means of the loudspeaker and/or to deactivate the loudspeaker.

The feedback signal generator may comprise a vibration generator in some embodiments, wherein the camera status feedback signal may comprise a vibration signal that is generated by the vibration generator and that can be sensed by an operator of the remote control unit. An operator holding the remote control unit may also be reliably made aware of a change of the camera to the recording state by such a directly haptically perceivable camera status feedback signal without having to constantly keep the motion picture camera or the remote control unit in view.

The feedback signal generator may in particular be configured to generate such a vibration signal as an alternative to or in addition to a directly and/or indirectly acoustically perceivable sound signal. Provision may, for example, be made that the camera status feedback signal comprises, in addition to the directly haptically perceivable vibration signal, an indirectly acoustically perceivable sound signal that is generated at headphones coupled to the remote control unit via an audio signal output. Due to such a camera status feedback signal that can be perceived multiple times, an operator of the remote control unit, who takes off headphones provided for transmitting an indirectly acoustically perceivable camera status feedback signal during an interruption of the shoot, can, for example, be made aware of the change of the camera to the recording state by the additionally generated haptically perceivable vibration signal. Conversely, an operator who, for example, puts down the remote control unit for a short time may be informed of this change via the headphones.

The evaluation and control device may be configured, in response to a received operating state signal that represents a change of the associated camera from the recording state back to the standby state, to control the feedback signal generator to generate a further camera status feedback signal that is directly or indirectly acoustically and/or haptically perceivable. A termination of the shoot may thereby also be reliably transmitted to the operator of the remote control unit so that any coordination difficulties between a cameraman guiding the camera and the operator may also be excluded on such a change of the operating state of the camera. In embodiments that comprise a selector, the further camera status feedback signal may also be selectively suppressed by means of this selector.

The camera status feedback signal and the further camera status feedback signal may differ from one another. Due to such a distinguishability of the respective camera status feedback signals, it may be achieved that it is always clearly visible to an operator of the remote control unit to which operating state the camera has changed. For example, in the case of directly or indirectly acoustically perceivable feedback signals, the level or frequency of a generated sound and/or the number of generated sounds may differ from one another in dependence on the change of the operating state of the camera that has taken place or respective sound sequences that differ from one another may be generated. In the case of haptically perceivable camera status feedback signals, the number of vibrations that occur may differ, for example.

In some embodiments, the evaluation and control device may be configured to control the feedback signal generator, in dependence on the control command that is set by the operator by means of the operating element, to generate a setting value feedback signal that is directly or indirectly acoustically and/or haptically perceivable. In such embodiments, the feedback signal generator may consequently not solely serve to indicate a change of the operating state of the camera, but it may, for example, also make an operator aware of the reaching of a provided control command or of a position or movement of the operating element corresponding thereto (e.g. reaching a predetermined focal position). The operator may thereby in particular set the control commands without having to constantly keep the remote control unit in view and may instead continuously observe the scene to be recorded to be able to ensure the correct setting in time of the control commands. The setting value feedback signals may in this respect be generated and/or handled in the same way as the camera status feedback signals explained above. The setting value feedback signals may thus also, if necessary, be transmitted to an external sound generator and/or may be selectively suppressed.

The feedback signal generator may be configured to generate associated and mutually distinguishable setting value feedback signals for different control commands. Provision may, for example, be made that, as a result of an adjustment of the operating element, the set control command or a value of a recording parameter that is set at the camera, for example a focal position, is acoustically communicated to the operator (e.g. as a synthetic voice message). The operator may thereby always be informed about the settings made.

The feedback signal generator may comprise an optical signal generator that is configured to generate optically perceivable display signals as an alternative to or in addition to the camera status feedback signals. The operator may also be made aware of a change of the operating state of the camera by such optically perceivable display signals. Such display signals may in particular be provided in addition to the acoustically and/or haptically perceivable camera status feedback signals or on a selective suppression of the camera status feedback signals. For example, even in situations in which the generation of an acoustically perceivable camera status feedback signal could result in disruptions of the recording operation, the operator of the remote control unit may thereby be made aware of a change of the operating state of the camera by the optically perceivable signal.

Provision may be made that the remote control unit comprises a base part that may in particular have a handle for holding the remote control unit, wherein the operating element is movable relative to the base part, and wherein the control commands correspond to a respective position or movement of the operating element relative to the base part. The movable operating element may, for example, comprise a button;

a switch; a rotary actuator (e.g. an adjustment wheel); and/or a linear actuator (e.g. a slider). Such a movable operating element may in particular comprise a rotatable adjustment wheel by means of which the control commands or respective desired values of parameters to be changed at the camera may be set.

The remote control unit may comprise a display device for displaying at least one symbol, wherein the evaluation and control device may be configured to change the position or the value of the symbol in dependence on the set control command. Such a display device may enable the operator to check the setting made by means of by the operating element and, if necessary, to adapt the control command transmitted to the camera if the set parameter does not have the intended value. The display device may in particular be configured to directly display the value of a set parameter in order to provide a simple possibility for checking/monitoring.

In some embodiments, the control signal output may be configured for a wireless transmission of the actuating motor control signal to the associated camera and the operating state signal input may be configured for a wireless reception of the operating state signals from the associated camera. The control signal output and the operating state signal input may thus be configured as radio modules or may be connected to a radio module to enable a wireless communication between the remote control unit and the associated camera. It may thereby in particular be achieved that an operator of the remote control unit only has to stay in sufficient proximity to the camera in order to enable an exchange of radio signals between the camera and the remote control unit.

The invention will be explained in the following purely by way of example with reference to possible embodiments and to the drawings.

There are shown:

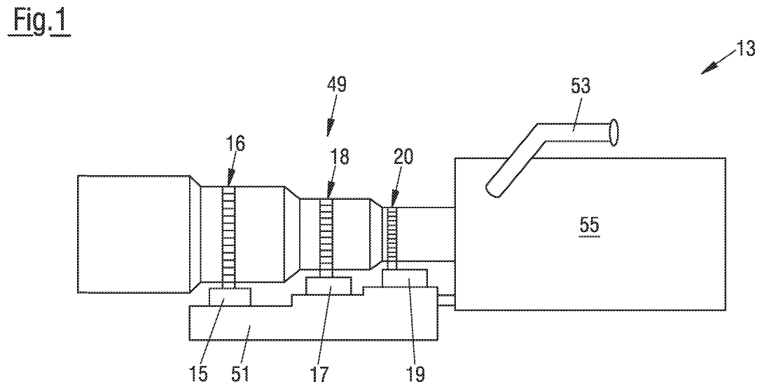

FIG. 1 a schematic representation of a motion picture camera;

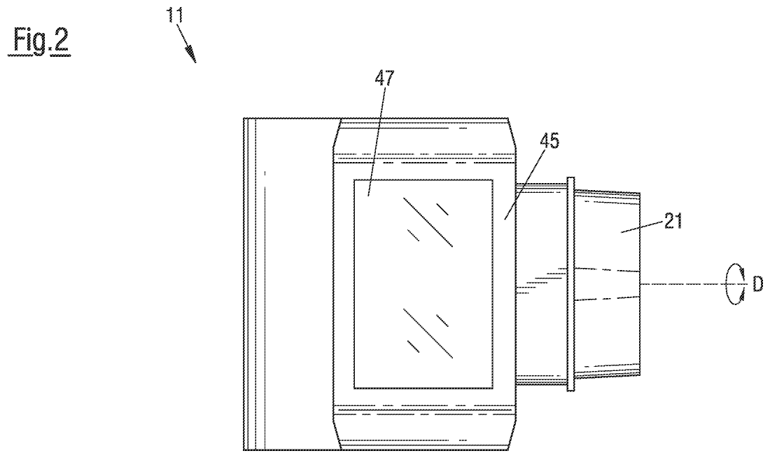

FIG. 2 an exemplary view of a remote control unit for the motion picture camera; and

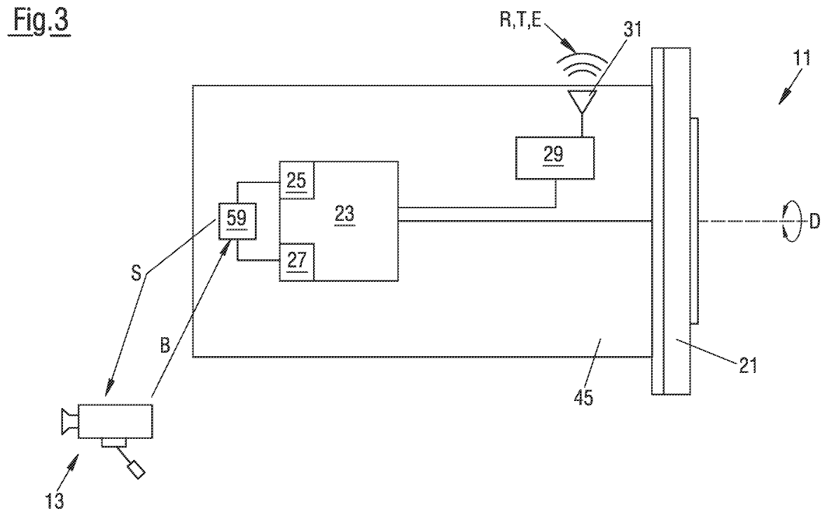

FIGS. 3 to 6 respective schematic representations of possible embodiments of the remote control unit to illustrate its mode of operation.

FIG. 1 shows a motion picture camera 13 having a camera body 55 at which an interchangeable objective 49 is mounted. This interchangeable objective 49 has three lens rings 16, 18 and 20 that may be adjusted by means of respective external lens actuating motors 15, 17, and 19. For example, the first lens ring 16 may in this respect be provided to set the focal distance of the objective 49, while a desired focal length setting may, for example, be performed by the rotation of the second lens ring 18. Furthermore, the third lens ring 20 may in particular be provided to be able to set an iris aperture opening by means of the associated third lens actuating motor 19. The actuating motors 15, 17, and 19 are in this respect part of a lens ring drive unit 51 that is connected to the camera body 55 (e.g. via holding rods), but that may be a unit separate and independent of the motion picture camera 13. However, the actuating motors 15, 17, 19 and the lens ring drive unit 51 are associated with a respective motion picture camera 13 via the interchangeable objective 49 used. The lens ring drive unit 51 may comprise a communication interface and/or a control circuit for a reception of actuating motor control signals or for a corresponding control of the lens actuating motors 15, 17, 19. Furthermore, a viewfinder 53 is arranged at the camera body 55, by means of which viewfinder 53 a cameraman guiding the motion picture camera 13 may focus on an image section to be recorded.

Since the motion picture camera 13 is equipped with an interchangeable objective 49 that is connectable to the camera body 55, objectives 49 of a different design may generally also be connected to the camera body 55 to be able to flexibly provide a motion picture camera 13 that enables ideal settings for a scene to be recorded. For example, objectives 49 having a fixed focal length may also be provided that only have two lens rings 16 and 20 for adjusting the focal position and the iris aperture opening by means of associated actuating motors 17 and 19.

During a recording of a scene, provision is generally made that the camera 13 or its objective 49 is moved by a cameraman to focus on a respective image section to be recorded. Corresponding adaptations of the recording parameters which possibly have to be made on such a change of the image section, for example of the focal distance, are in contrast usually performed by a camera assistant or a focus puller by means of a remote control unit 11 whose possible design is illustrated in FIG. 2.

In this respect, the motion picture camera 13 shown here with the objective 49 only serves for the illustration. In general, the remote control unit 11 may also be configured to set other types of motion picture cameras 13 or other types of objectives 49 in a remote-controlled manner that may, for example, have integrated lens actuating motors instead of the lens rings 16, 18, 20 rotatable from the outside for the external actuating motors 15, 17, 19.

The remote control unit 11 shown in FIG. 2 has an operating element 21 that is configured as an adjustment wheel and that is rotatable about an axis of rotation D relative to a base part 45. Due to the rotation of the operating element 21 or to the change of its rotational position relative to the base part 45, control commands for the camera 13 may in this respect be set that are transmitted as actuating motor control signals S to the motion picture camera 13 or to the associated lens ring drive unit 51 having the lens actuating motors 15, 17, and 19 (cf. also FIGS. 3 to 6).

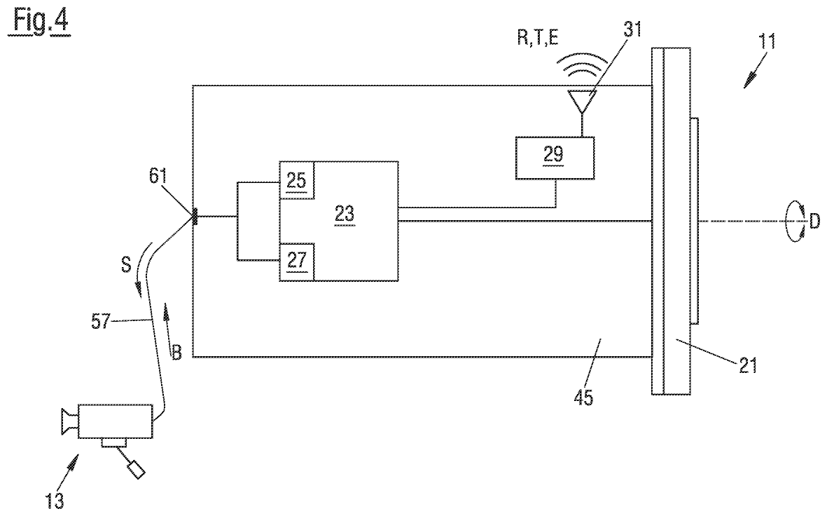

As FIGS. 3 to 6 show, the remote control unit 11 for this purpose has an evaluation and control device 23 that is connected to the operating element 21 or to the base part 45 and that is configured to detect the set control command for the camera 13 and to generate a corresponding actuating motor control signal S. In order to transmit the generated actuating motor control signal S to the camera 13, the evaluation and control device 23 comprises a control signal output 25. In this respect, the control signal output 25 may be connected to a radio module 59 to be able to transmit the actuating motor control signal S in a wireless manner, in particular via a radio link, to the camera 13 (cf. FIGS. 3, 5, and 6). This may in particular enable the operator of the remote control unit 11 to position himself during a shoot at a location that makes it possible to have an optimal overview of the recording operation without the operator having to follow any movements of the cameraman. Alternatively to this, provision may, however, also be made that the control signal output 25 is connected to a wired camera connection 61 via which the camera 13 or an associated external lens ring drive unit 51 is connectable to the remote control unit 11 via a cable 57 (cf. FIG. 4).

To facilitate the checking of a correct setting of the remote-controlled motion picture camera 13, the remote control unit 11 further has a display device 47 that is configured to display a symbol and to change the symbol and/or its position in dependence on the set control command (cf. FIG. 2). The respective currently set value of a set recording parameter, for example a focal length, may in particular in this respect be displayed on the display device 47 so that an operator of the remote control unit 11 may immediately check the setting made.

It is important for a camera assistant or a focus puller operating the remote control unit 11 to be able to reliably perceive the start of a moving image recording so that he may then set a planned or rehearsed sequence of control commands at the remote control unit 11. An acoustically and/or haptically perceivable signaling is provided to indicate such a change of the operating state of the camera 13 in a reliably perceivable manner to the operator of the remote control unit 11.

For this purpose, the remote control unit 11 has an operating state signal input 27 for receiving operating state signals B from the camera 13. This reception of the operating state signals B can, like the transmission of the actuating motor control signal S by means of the control signal output 25, take place in a wireless manner via the radio module 59 (cf. FIGS. 3, 5, and 6) and/or in a wired manner via a camera connection 61 (cf. FIG. 4). Furthermore, the remote control unit 11 comprises a feedback signal generator 29, wherein the evaluation and control device 23 is configured, in response to a reception of the operating state signal B that represents a change of the associated camera 13 to the recording state, to control the feedback signal generator 29 to generate a directly or indirectly acoustically and/or haptically perceivable camera status feedback signal R. Since this feedback signal R is acoustically and/or haptically perceivable, it may be achieved that the operator of the remote control unit 11 is reliably made aware of a change of the camera 13 to the recording state even if the operator does not constantly keep the motion picture camera or the remote control unit in view.

In the embodiment shown in FIG. 3, the feedback signal generator 29 is connected to a loudspeaker 31 to generate a directly acoustically perceivable feedback signal R.

In response to an operating state signal B received wirelessly by means of the radio module 59 via the operating state signal input 27 from the camera 13, the feedback signal generator 29 may be caused by the evaluation and control device 23 to generate a sound signal T via the loudspeaker 31 that forms the camera status feedback signal R here. Due to such a directly acoustically perceivable camera status feedback signal R, the operator of the remote control unit 11 may be made aware of a change of the camera 13 to the recording state that has taken place.

Similarly, in accordance with the embodiment of FIG. 4, such a sound signal T or a directly acoustically perceivable camera status feedback signal R may be generated by means of the loudspeaker 31 in response to an operating state signal B transmitted via a cable 57 and received at a camera connection 61.

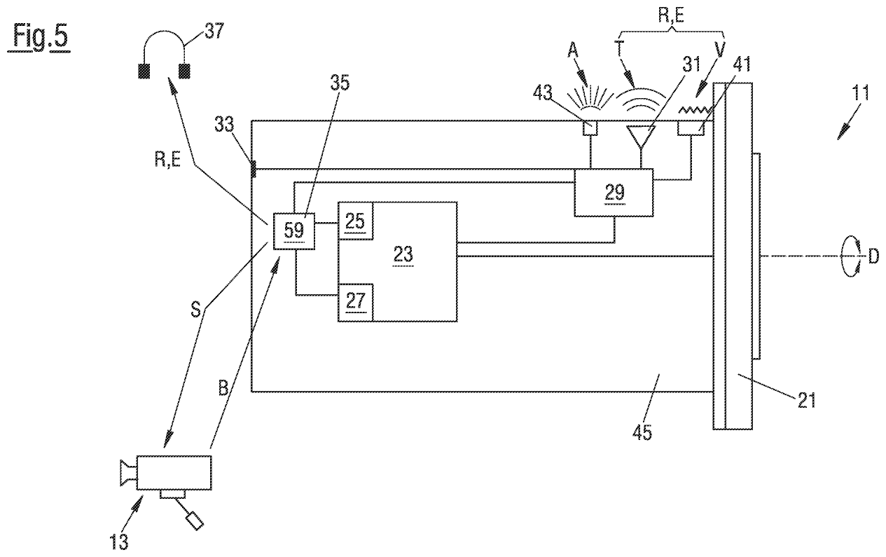

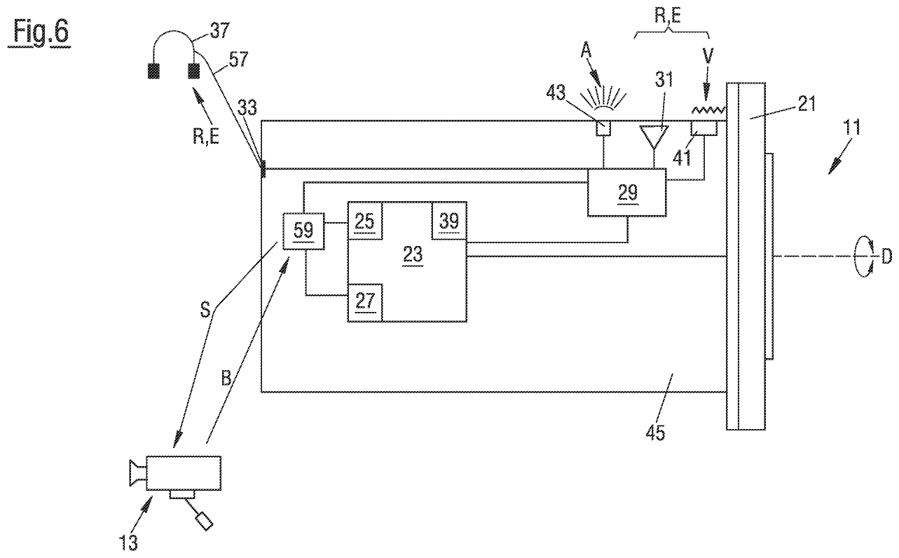

As FIG. 5 illustrates, the feedback signal generator 29 may also be connected to a radio module 59 (in particular to the radio module 59 already mentioned or to another radio module). This can make it possible to wirelessly transmit a generated camera status feedback signal R to an external sound generator 37 that is configured as headphones here. For example, a transmission via a Bluetooth connection in accordance with a common transmission protocol may be provided in this respect. In addition to this radio module 59 functioning as a wireless audio signal output 35, the feedback signal generator 29 may furthermore be connected to a wired audio signal output 33 (e.g. a headphone socket) by which the external sound generator 37 is connectable to the remote control unit 11 via a cable 57 (cf. also FIG. 6).

By transmitting the camera status feedback signal R to an external sound generator 37 and in particular to headphones, an indirectly acoustically perceivable camera status feedback signal R, namely a camera status feedback signal R that is acoustically perceivable at the connected sound generator 37, may be generated. Due to such a transmission to headphones 37, it may in particular be achieved that the operator of the remote control unit 11 reliably becomes aware of a change of the operating state of the camera 13 without, for example, further persons located in the vicinity of the remote control unit 11 being disturbed by a directly acoustically perceivable camera status feedback signal R. For this purpose, as FIG. 6 illustrates, the evaluation and control device 23 may be configured to automatically suppress the generation of a sound signal T by means of the loudspeaker 31 if the external sound generator 37 is connected to the remote control unit 11. Similarly, such a suppression of the sound signal T may also be provided if a wireless connection between the radio module 59 and an external sound generator 37 is detected.

Provision may generally also be made to configure the remote control unit 11 without a loudspeaker 31 and solely for a generation of indirectly acoustically perceivable camera status feedback signals R by means of an external sound generator 37 and in particular at headphones.

As FIGS. 5 and 6 further show, the feedback signal generator 29 may have a vibration generator 41 in addition to, but generally also as an alternative to, the loudspeaker 31 so that the camera status feedback signal R may comprise a directly haptically perceivable vibration signal V. An operator of the remote control unit 11, who holds the remote control unit 11 in his hand during an interruption of the recording operation, may also be directly and reliably made aware of a change of the camera 13 to the recording state by means of such a haptically perceivable vibration signal V. Furthermore, the feedback signal generator 29 may be connected to an optical signal generator 43 to be able to indicate the change of the camera 13 to the recording state to the operator of the remote control unit 11 additionally by means of an optically perceivable display signal A.

Furthermore, provision may be made that the evaluation and control device 23 is configured to also control the feedback signal generator 29 to generate an acoustically and/or haptically perceivable camera status feedback signal R in the case of a change of the camera 13 from the recording state to the standby state. The camera status feedback signals R may in this respect in particular differ from one another in dependence on the change that has taken place. Furthermore, the remote control unit 11 may comprise a selector 39 (e.g. a mechanical or a virtual switch) by means of which the generation of a camera status feedback signal R for a respective operating state signal B may be selectively suppressed (cf. FIG. 6). Alternatively or additionally, the remote control unit 11 may have a switch 39 by means of which the generation of sound signals at the loudspeaker 31 may be selectively switched off.

Provision may likewise be made that the evaluation and control device 23 is configured to generate acoustically and/or haptically perceivable setting value feedback signals E by means of the feedback signal generator 29 in dependence on the set control command. For example, provision may be made to generate an acoustically perceivable sound signal T by means of the loudspeaker 31 or an external sound generator 37 when a parameter of the camera 13 reaches a predetermined value. The operator of the remote control unit 11 may thus continuously observe the recording operation during the setting of the camera 13 or of the objective 49 without having to look at the remote control unit 11 to check the setting. In this respect, the setting value feedback signal E may be handled in the same manner as a camera status feedback signal R and may, for example, also be transmitted to a coupled external sound generator 37.

Whereas the control signal output 25 and the operating state signal input 27 are shown as included by the evaluation and control device 23 in FIGS. 3 to 6, the control signal output 25 and the operating state signal input 27 may likewise be provided as separate modules and may merely be connected to the evaluation and control device 23. Furthermore, the control signal output 25 and the operating state signal input 27 may, for example, be configured as a common module in the form of a transceiver. Alternatively to a separately provided radio module 59, the control signal output 25, the operating state signal input 27, and the feedback signal generator 29 may furthermore themselves also comprise respective radio modules or be configured as such.

The remote control unit 11 consequently provides a simple possibility of informing its operator of a change of the associated motion picture camera 13 from the standby state to the recording state and of ensuring a perception of this operating state change. Possible disruptions of the recording operation due to a missing of the start of a recording and absent or delayed settings of the parameters of the camera 14 that are thereby caused may thus be reliably prevented.

### REFERENCE NUMERAL LIST

11 remote control unit
13 motion picture camera
15 first lens actuating motor
16 first lens ring
17 second lens actuating motor
18 second lens ring
19 third lens actuating motor
20 third lens ring
21 operating element
23 evaluation and control device
25 control signal output
27 operating state signal input
29 feedback signal generator
31 loudspeaker
33 wired audio signal output
35 wireless audio signal output
37 external sound generator
39 selector, switch
41 vibration generator
43 optical signal generator
45 base part
47 display device
49 interchangeable objective
51 lens ring drive unit
53 viewfinder
55 camera body
57 cable
59 radio module
61 camera connection
A display signal
B operating state signal
D axis of rotation
E setting value feedback signal
R camera status feedback signal
S actuating motor control signal
T sound signal
V vibration signal

1. A remote control unit for a motion picture camera having a lens actuating motor, comprising
a movable operating element for setting control commands for an associated camera;
an evaluation and control device for generating an actuating motor control signal for the associated camera in dependence on the set control command;
a control signal output for transmitting the actuating motor control signal to the associated camera;
an operating state signal input for receiving operating state signals from the associated camera; and
a feedback signal generator,
wherein the evaluation and control device is configured, in response to a received operating state signal that represents a change of the associated camera from a standby state to a recording state, to control the feedback signal generator to generate a camera status feedback signal that is directly or indirectly perceivable in at least one of an acoustic or haptic manner.

2. A remote control unit in accordance with claim 1,
wherein the feedback signal generator has a loudspeaker, and wherein the camera status feedback signal comprises an acoustically perceivable sound signal generated by the loudspeaker.

3. A remote control unit in accordance with claim 2,
wherein the volume of the generated sound signal is adjustable.

4. A remote control unit in accordance with claim 2,
wherein the remote control unit has a switch by means of which the generation of the sound signal can be selectively switched off.

5. A remote control unit in accordance claim 1,
wherein the feedback signal generator has at least one of a wired audio signal output or a wireless audio signal output via which the camera status feedback signal can be transmitted to a coupled external sound generator.

6. A remote control unit in accordance with claim 1,
wherein the remote control unit comprises a selector by means of which the generation of the camera status feedback signal can be selectively suppressed.

7. A remote control unit in accordance with claim 1,
wherein the feedback signal generator has a loudspeaker and a wired and/or a wireless audio signal output, and wherein the evaluation and control device is configured, in response to the received operating state signal, to control the feedback signal generator to output the camera status feedback signal via the audio signal output and said evaluation and control device is, however, configured to suppress an output of a sound signal generated by the loudspeaker when an external sound generator is coupled to the audio signal output.

8. A remote control unit in accordance with claim 1,
wherein the feedback signal generator has a vibration generator, and wherein the camera status feedback signal comprises a vibration signal that is generated by the vibration generator and that can be sensed by an operator of the remote control unit.

9. A remote control unit in accordance with claim 1,
wherein the evaluation and control device is configured, in response to a received operating state signal that represents a change of the associated camera from the recording state to the standby state, to control the feedback signal generator to generate a further camera status feedback signal that is directly or indirectly perceivable in at least one of an acoustic or haptic manner.

10. A remote control unit in accordance with claim 9,
wherein the camera status feedback signal and the further camera status feedback signal differ from one another.

11. A remote control unit in accordance with claim 1,
wherein the evaluation and control device is configured to control the feedback signal generator, in dependence on the control command set by means of the operating element, to generate a setting value feedback signal that is directly or indirectly perceivable in at least one of an acoustic or haptic manner.

12. A remote control unit in accordance with claim 1,
wherein the remote control unit comprises a base part, wherein the operating element is movable relative to the base part, and wherein the control commands correspond to a respective position or movement of the operating element relative to the base part.

13. A remote control unit in accordance with claim 1,
wherein the control signal output is configured for a wireless transmission of the actuating motor control signal to the associated camera, and wherein the operating state signal input is configured for a wireless reception of the operating state signals from the associated camera.
